(19) United States
(12) Patent Application Publication
(10) Pub. No.: US 2017/0072590 A1
(43) Pub. Date: Mar. 16, 2017

(54) POST WITH METAL CAGE REINFORCEMENT AND METHOD FOR MANUFACTURING SAME

(71) Applicant: John C. Barnett, FT. Meade, FL (US)

(72) Inventor: John C. Barnett, FT. Meade, FL (US)

(21) Appl. No.: 15/261,306

(22) Filed: Sep. 9, 2016

Related U.S. Application Data
(60) Provisional application No. 62/219,505, filed on Sep. 16, 2015.

(51) Int. Cl. B28B 1/16; E04H 12/12; B21D 11/20; B28B 17/00

(52) U.S. Cl. CPC B28B 1/16; B28B 17/0009; E04H 12/12; B21D 11/20

(57) ABSTRACT

Described is a method of manufacturing a metal cage reinforced concrete post using off-the-shelf materials and tools. The reinforcement cage is manufactured using pre-fabricated wire mesh. The wire mesh is flattened and cut using a specific pattern that provides for elements analogous to rods, stirrups, and extensions that are used to space the cage within a mold to insure optimal placement during concrete forming. The purpose-cut wire mesh is formed into a cage-like shape by use of a bending press, a hydraulic molding press, hand tools or other suitable means. The extension elements are subsequently bent to form lateral and vertical spacer elements which center the cage within a mold. The cage is then placed within a forming mold and concrete, or another suitable material, is poured in. Once the material is dry, the reinforced post is removed from the mold fully formed.

### CLAIM OF PRIORITY

This application is being filed as a non-provisional patent application under 35 U.S.C. §111(b) and 37 CFR §1.53(c). This application claims priority under 35 U.S.C. §111(e) to U.S. provisional patent application Ser. No. 62/219,505 filed on Sep. 16, 2015, the contents of which are incorporated herein by reference.

### FIELD OF INVENTION

The present invention relates to a method of manufacturing a reinforced post, and more specifically to a method of manufacturing a post having a reinforced metal cage using off-the-shelf materials, without the need for specialized tools or skills, and at minimal cost.

### BACKGROUND OF THE INVENTION

Posts are used and installed to serve as support for a variety of exterior structures, such as fences, decks, signs, and the like. Materials used for making posts vary and commonly include, wood, aluminum, steel, sheet metal, and concrete. Concrete is a preferred material due to its durability and strength, however, to be most effective, concrete posts, as do most concrete structures, require internal reinforcement. The reason for the need for reinforcement is that concrete has very good compressive strength but poor tensile and flexural strength. Internal reinforcement, commonly metallic, and most commonly steel, provides the required tensile and flexural strength needed by a concrete post. Typically, concrete reinforcement of posts requires embedding a plurality of longitudinal metallic elements along the entire length of the post. A plurality of members is required because although a single member could provide tensile strength to the post, a single member provides poor flexural strength. Flexural strength is of critical importance in many applications where the concrete post is subjected to a bending load.

A common methodology for reinforcing concrete posts is to embed a rectangular or circular steel “cage” within the concrete body of post, extending from tip to tip of the post. The cage is painstakingly constructed by arranging the longitudinal members (i.e., the “rods”, normally lengths of steel reinforcement rods or “rebar”) in the desired configuration (either circular or rectangular) and then placing and attaching numerous rectangular or circular hoops (commonly called “stirrups”) around the longitudinal members and at periodic distances along the length of the longitudinal members, to support them.

Because reinforced concrete posts are formed by pouring concrete within a mold, and the reinforcing elements must be located within the interior body of the post, additional spacing elements (or “spacers”) are needed to properly position the cage within the mold. These spacing elements, which must be separately and individually attached to the cage, maintain a required distance between the walls of the mold and the reinforcing cage.

Due to the difficulties of making and using reinforcing cages using the aforementioned techniques known in the prior art, manufacturing of concrete posts, until now, has been a difficult and expensive process. As a result, reinforced concrete posts have fallen out of favor and are only used in the most demanding applications where significant expense is justified. In other applications, where low expense is paramount, wood or sheet metal posts, having inferior strength and durability, must be used which results in low performance and premature replacement of the post.

The present invention solves this problem by providing an easy and inexpensive method for forming a concrete post reinforcement cage using off-the shelf materials and tools. The concrete post reinforcement cage manufactured using the present invention incorporates elements analogous in function to rods, stirrups and spacers into one unitary structure that is easily and inexpensively formed. The method for manufacturing a reinforced concrete post herein disclosed provides flexibility in the design of the cage and allows for various post configurations that provide ample compressive, tensile and flexural strength without increasing material costs, tooling costs, or requiring significant manufacturing skills.

Although the embodiments specified in the present disclosure use concrete, the present invention can be applied to other materials, and should not be limited to concrete. Other materials that may be poured and dried to harden, such as cement, resins, and the like, could be used in conjunction with the described method to achieve similar results. In addition, a variety of aggregates, including sand, rock and synthetic or natural fibers may be admixed with cement or other materials and used to form the post of the present invention.

### SUMMARY OF THE INVENTION

It is an object of the present invention to overcome the disadvantages of existing manufacturing methods by providing a method of manufacturing a metal cage reinforced concrete post using off-the-shelf materials. It is a further object of the present invention to provide a method of manufacturing a metal cage reinforced concrete post which does not require advanced tooling or skills. It is a further object of the present invention to provide a method of manufacturing a metal cage reinforced concrete post in which all elements of the reinforcing cage, namely the rods, the stirrups and the spacers, are of unitary construction.

The present invention describes a method of manufacturing a metal cage reinforced concrete post using off-the-shelf materials and tools. The reinforcement cage is manufactured using pre-fabricated wire mesh, which can be purchased in rolls at any home improvement or hardware store. The wire mesh is flattened and cut using a specific pattern that provides for elements analogous to rods, stirrups, and extensions that are used to space the cage within a mold to insure optimal placement during concrete forming. The purpose-cut wire mesh is formed into a cage-like shape by use of a bending press, a hydraulic molding press, hand tools or other suitable means. The extension elements are subsequently bent to form lateral and vertical spacer elements which center the cage within a mold. The cage is then placed within a forming mold and concrete is poured in. Once the concrete is cured, the post is removed from the mold fully formed and ready for use.

### BRIEF DESCRIPTION OF THE DRAWINGS

These and other features, aspects, and advantages of the present invention will become better understood with regard to the following description, appended claims, and accompanying drawings where:

FIG. 1 illustrates a roll of cage wire mesh material used in various embodiments of the present invention.

FIG. 2 illustrates a flat blank for a reinforcement cage in accordance with an embodiment of the present invention.

FIG. 3 illustrates a partially completed reinforcement cage in accordance with an embodiment of the present invention after the flat blank has been bent along the interior longitudinal columns.

FIG. 4 illustrates a completed reinforcement cage made in accordance with an embodiment of the present invention.

FIG. 5 illustrates a reinforcement cage in accordance with an embodiment of the present invention placed within a concrete mold for a concrete post.

FIG. 6 illustrates a completed metal cage reinforced concrete post in accordance with an embodiment of the present invention.

### DETAILED DESCRIPTION OF INVENTION

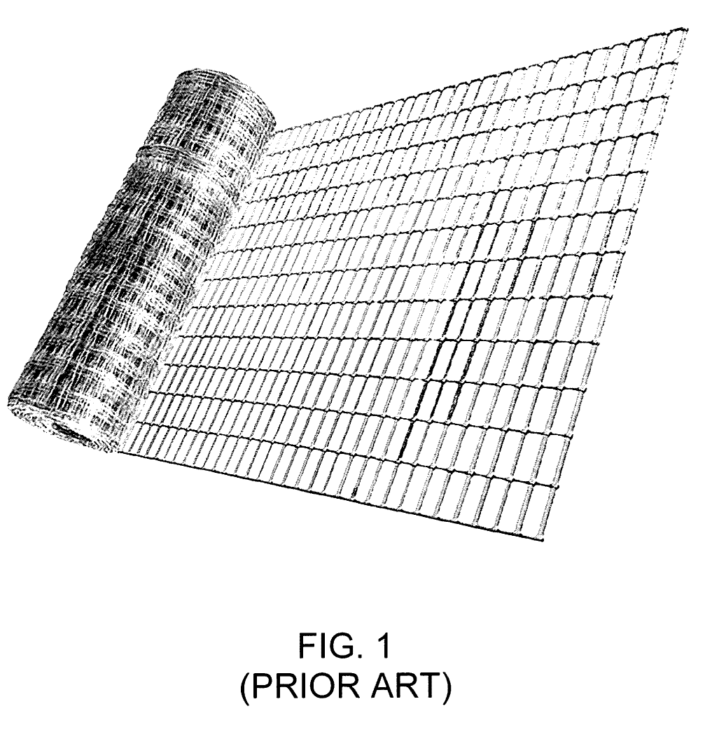

The present invention is a reinforced concrete post, and the method of manufacturing same. To start, the user will need to acquire a roll of pre-fabricated cage wire material or mesh. This material is often sold in 6-foot rolls with a 1-in (wide) by 2-in (tall) rectangles made of 14 gauge galvanized steel wires. However, other sizes, gauges and configurations of cage wire material are available or possible, and would also be suitable to practice the disclosed invention. A sample, partially unrolled roll of the cage wire mesh material is shown in FIG. 1. This material can be purchased at home improvement, manufacturing or construction stores, such as Home Depot®, Lowe's®, Grainger®, etc. The cage wire mesh does not need to fit the dimensions mentioned above. This invention can be applied to cage wire mesh of different roll heights, lengths, sized rectangles, or even material other than 14 gauge galvanized steel. This material is often manufactured by welding vertical and horizontal wires into a rectangular or square grid, however, material made by methods other than welding is equally suitable. Although the following description sometimes refers to it as welded cage wire mesh, it should be understood that the material need not be made by welding or bay any other specific method.

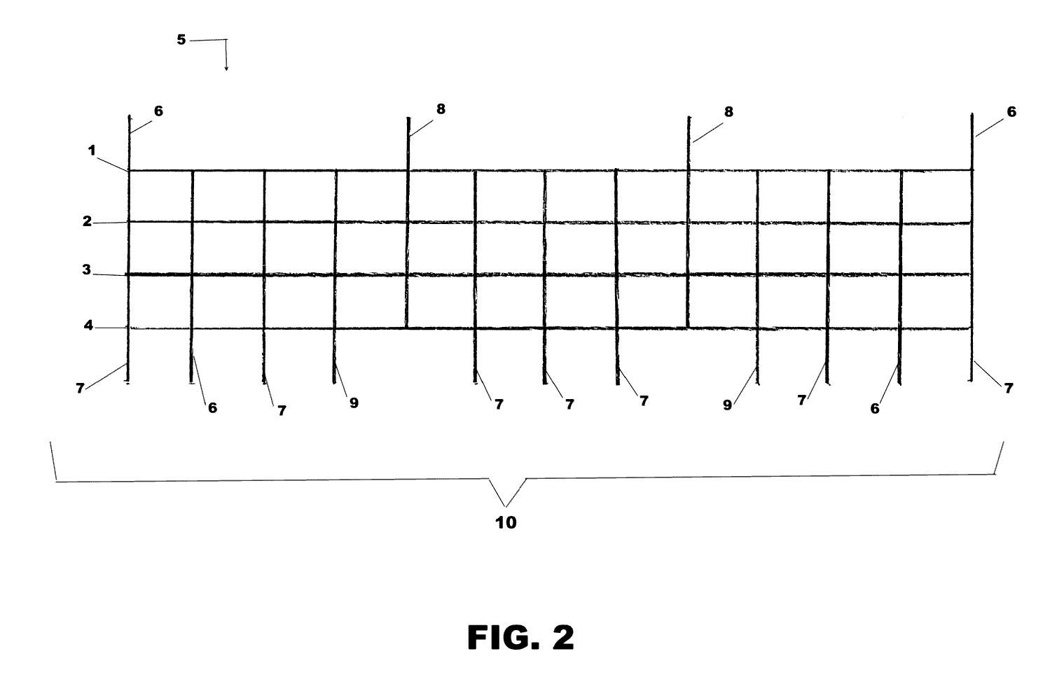

Once the cage wire mesh has been procured, it is cut to create a “blank” (5) having a pattern similar to the one seen in FIG. 2. In this embodiment, the cage wire mesh is cut into a grid having four longitudinal columns (1, 2, 3, 4) with extra wire strands (6, 7, 8, 9) extending from the sides of both outside columns (1, 4) at different intervals. It is possible to practice the present invention with different lengths (10) of cage wire mesh depending on the final length of the resulting concrete post. In the embodiment shown in FIG. 2 the extra wire strands (6, 7, 8, 9) are located along the entire length (10) of the blank. However in alternative embodiments some of the extra strands can be removed and the remaining strands are switched between being positioned off of either outside longitudinal column (1, 4) approximately every 3-5 rows. This pattern can be changed based on the desired ultimate length of the concrete post.

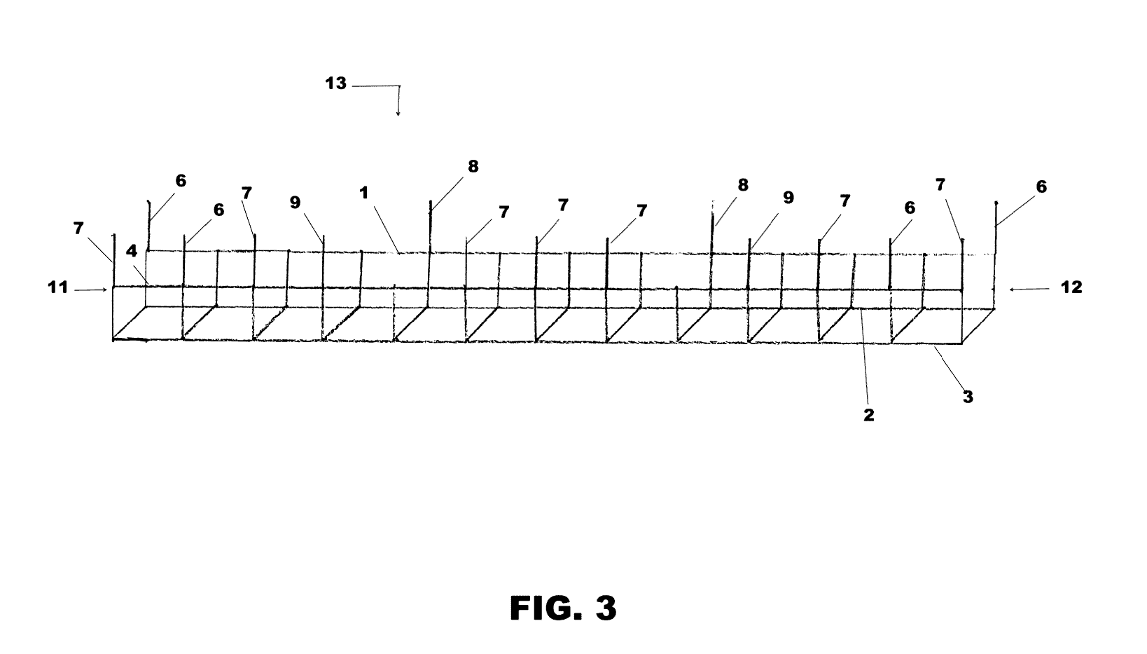

Proceeding next to FIG. 3, once the cage wire mesh blank has been cut, the user bends the blank twice along the internal longitudinal columns (2, 3) to create a square “U” when viewed from an end (11, or 12). This bending of the blank can be accomplished by sequentially bending along internal longitudinal columns (2, 3) by means of a bending press or by any other conventional method. Alternatively, the blank can be pressed into a square using a hydraulic press or any other conventional method simultaneously bending both sides. As shown in FIG. 3, the partially folded blank (13) forms a square cage with an open end. When initially folded along the internal longitudinal columns (2, 3), the extra wire strands (6, 7, 8, 9) are not bent and are therefore left facing straight out in their original orientation. The extra wire strands (6, 7, 8, 9) are then put into one of four different final orientations: (b) extra wire strands (6) remain straight; (b) extra wire strands (7) are bent inward to create a complete square when viewed from an end; (c) extra wire strands (8) are bent outward with respect to outside column (1); and (d) extra wire strands (9) are bent outward with respect to outside column (4).

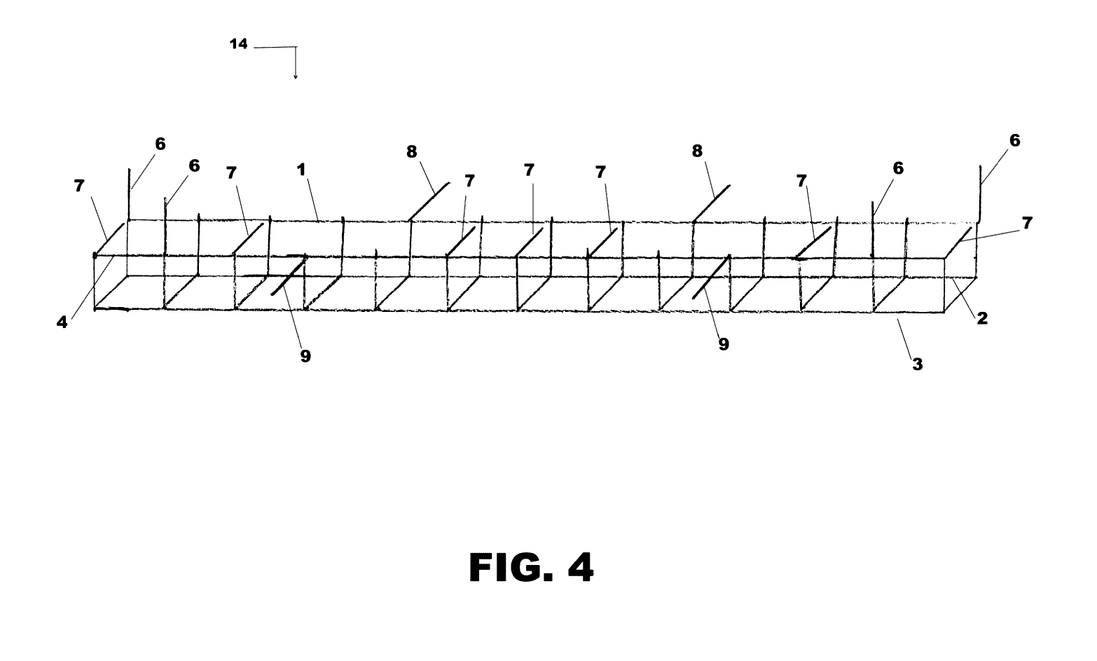

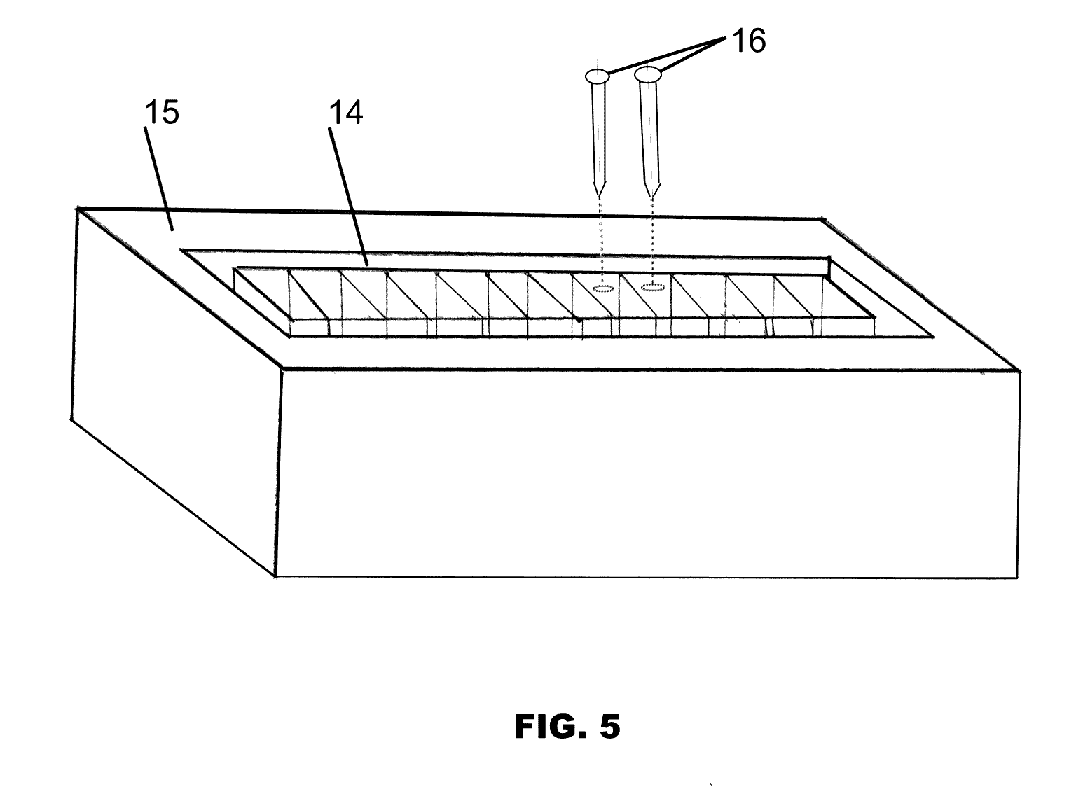

While it is preferable to have at least 4 extra wire strands (6) remain straight, 2 extra wire strands (8) bent outward with respect to outside column (1); and 2 extra wire strands (9) bent outward with respect to outside column (4), the present invention can be practiced with as few as 1 each of extra wire strands (6, 8, 9) pointed in each direction. It is not required to have any extra wire strands (7) bent inward. Extra wire strands (6, 8, 9) act as standoffs to keep the wire mesh cage separated from, and centered within, the side and bottom walls of the concrete mold (see FIG. 5 item 15) where the post is eventually constructed. All extra wire strands that are not bent outwards or left straight, can be bent inwards to complete the square side of the cage and add structural rigidity. Alternatively, extra wire strands that are not needed can be removed by cutting. A completely formed wire mesh cage (14) is shown in FIG. 4.

Once the wire mesh cage is completed, the cage (14) is placed into a mold (15), as shown in FIG. 5. In this embodiment, the cage is placed with the straight extra wires (6) facing downwards so that they act as legs to keep the cage elevated inside mold (15). Once the cage is properly placed within the mold (15), and laterally centered with the help of extra wire strands (8, 9), concrete, cement or some other suitable cementitious or otherwise hardening curable substance (e.g. resin, plastic, etc.) is poured into the mold. In an alternative embodiment of the method of the present invention, one or more nails or pins (16) may be optionally introduced (by hammering in or through manual insertion, for example) into the hardening curable substance when it is partially dry to form one or more passageways where fencing material, such as straight or barbed wire, can be attached once the final post is formed and placed into use. Alternatively, the passageways may be drilled into the hardening curable substance using a manual or powered drill. In yet another alternative embodiment, multiple side-by-side molds may be combined into a single structure holding multiple cages (14) so that multiple posts can be created from a single pour.

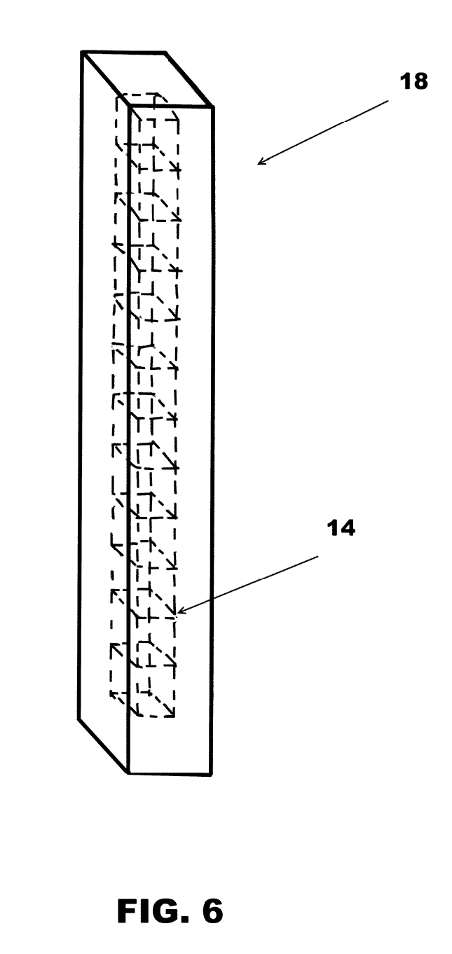

Once the concrete, cement or other material sets, the mold is removed a completed post (18) is extracted as shown in FIG. 6. Depending on the material used to form the post, additional cure time may be required before the post (18) is put to use. In different embodiments, the post may have different cross-sectional shapes (e.g., circular, rectangular, hexagonal, etc.) In addition, if multiple cages are used, or if a cage is bent at an angle after being formed, an angled post may be formed.

Other embodiments of the present invention and method involve cutting the wire mesh material into more or less than 3 rows to create cages with triangular, pentagonal, or hexagonal, etc. cross sections. Other possibilities include, but are not limited to, folding the wire mesh cage into different shapes and orientations to fit the need of the user. In one embodiment, the user may not bend the mold, but instead roll the mold into a circle or other curved shape.

Although the present invention has been described in considerable detail with reference to certain preferred versions thereof, other versions are possible. Therefore, the spirit and scope of the appended claims should not be limited to the description of the preferred versions contained herein.

I claim:

1. A method for manufacturing a reinforced post comprising the steps of:
separating from a bulk quantity of flat metallic wire mesh a reinforcement cage blank, the reinforcement cage blank comprising (a) four longitudinal wires including first and second outside longitudinal wires and first and second inside longitudinal wires, (b) a plurality of transverse wires extending perpendicularly from said first outside longitudinal wire, across said first and second inside longitudinal wires, to said second outside longitudinal wire, and (c) at least four extra wire strands terminating at one or both ends of each of said plurality of transverse wires and extending beyond said first or second outside longitudinal wires;
bending said reinforcement cage blank approximately 90 degrees about each of said first and second inside longitudinal wires to form a reinforcement cage with a rectangular “U” cross section;
bending at least one of said extra wire strands extending beyond said first outside longitudinal wire approximately 90 degrees so that it extends laterally and outwardly from said reinforcement cage;
maintaining at least three of said extra wire strands in an unbent condition so that they extend directly away from said reinforcement cage;
placing said reinforcement cage inside a hollow mold having a floor wherein said unbent extra wire strands are placed in direct contact with said floor and said reinforcement cage rests on said unbent extra wire strands;
pouring a hardening substance into said mold to substantially envelop said reinforcement cage; and
allowing said hardening substance to dry and extracting a completed reinforced post from said mold.

2. The method of claim 1, further comprising the following step prior to said placing step:
bending at least one of said extra wire strands extending beyond said second outside longitudinal wire approximately 90 degrees so that it extends laterally and outwardly from said reinforcement cage.

3. The method of claim 1, further comprising the following step prior to said placing step:
bending at least one of said extra wire strands extending beyond either of said first or second outside longitudinal wires approximately 90 degrees so that it extends inwardly in the direction of the opposing outside longitudinal wire.

4. The method of claim 1, wherein said hardening substance is concrete.

5. A reinforced post manufactured by the method of claim 1.

6. A method for manufacturing a reinforcement cage for a structure comprising the steps of:
separating from a bulk quantity of flat metallic wire mesh a reinforcement cage blank, the reinforcement cage blank comprising (a) four longitudinal wires including first and second outside longitudinal wires and first and second inside longitudinal wires, (b) a plurality of transverse wires extending perpendicularly from said first outside longitudinal wire, across said first and second inside longitudinal wires, to said second outside longitudinal wire, and (c) at least four extra wire strands terminating at one or both ends of each of said plurality of transverse wires and extending beyond said first or second outside longitudinal wires;
bending said reinforcement cage blank approximately 90 degrees about each of said first and second inside longitudinal wires to form a reinforcement cage with a rectangular “U” cross section;
bending at least one of said extra wire strands extending beyond said first outside longitudinal wire approximately 90 degrees so that it extends laterally and outwardly from said reinforcement cage; and
maintaining at least three of said extra wire strands in an unbent condition so that they extend directly away from said reinforcement cage.

7. The method of claim 6, further comprising the step of:
bending at least one of said extra wire strands extending beyond said second outside longitudinal wire approximately 90 degrees so that it extends laterally and outwardly from said reinforcement cage.

8. The method of claim 6, further comprising the step of:
bending at least one of said extra wire strands extending beyond either of said first or second outside longitudinal wires approximately 90 degrees so that it extends inwardly into said reinforcement cage.

9. The method of claim 6, wherein said hardening substance is concrete.

10. A reinforcement cage manufactured by the method of claim 6.
